(19) United States
(12) Patent Application Publication
(10) Pub. No.: US 2003/0229978 A1
(43) Pub. Date: Dec. 18, 2003

(54) Snap release device

(76) Inventor: Bernard Seiger, Cherry Hill, NJ (US)

Correspondence Address: CALFEE, HALTER & GRISWOLD, LLP, 1110 FIFTH THIRD CENTER, 21 EAST STATE STREET, COLUMBUS, OH, 43215-4243, US

(21) Appl. No.: 10/174,558

(22) Filed: Jun. 17, 2002

(51) Int. Cl. B23P 19/00

(52) U.S. Cl. 29/426.5; 29/268

(57) ABSTRACT

A hand-held tool for opening snap fasteners comprising a wedge-shaped unsnapping element that is compatible with snap fasteners of various sizes. The unsnapping element includes two notched plates each attached at an angle to an arm having a grip at the end opposite the notched plate. The two arms are attached together by a hinge, and a spring located near the hinge provides sufficient force to keep the two notched plates together when the device is in the closed position. The user of the device simply places the unsnapping element between the head and base of a closed snap fastener and squeezes the grips together. The two notched plates separate and the closed snap fastener is opened.

### STATEMENT REGARDING FEDERALLY SPONSORED R & D

This invention was not made by an agency of the United States Government nor under contract with an agency of the United States Government.

### TECHNICAL FIELD OF THE INVENTION

This invention relates generally to hand-held devices for unsnapping or releasing a variety of metal or plastic snaps, and specifically to a hand-held tool for unsnapping the snaps found on canopies or tarps used to cover vehicles such as boats.

### BACKGROUND OF THE INVENTION

Commercially available snap fasteners typically include a round snap base that is attached to a surface by a rivet, screw, or other means, and a snap head that is detachably held to the snap base by a resilient, expandable ring provided within the snap head. The snap head is often part of or attached to a covering material such as a canopy or tarp. The snap base is usually mounted on some portion of the surface of the item to be covered by the canopy or tarp. The canopy or tarp is secured to the item to be covered by placing the snap head against the snap base and pressing down until the snap head fully engages the snap base.

While snap fasteners provide a convenient way to attach a covering to the surface of an item such as a boat, the covering itself may be susceptible to excessive wear and damage at the point or points where the snap head is attached to the fabric of the covering. When unsnapping the snap fastener, the individual often simply grabs the cloth or plastic of the canopy or tarp near the snap head and pulls on the cloth or fabric to release the snap fastener. Unsnapping a snap fastener in this manner almost always weakens the material of the covering, and ultimately results in a torn or otherwise damaged covering. Once this type of damage has occurred, the covering is basically useless and must be replaced.

Matters are further complicated if snap fasteners are exposed to certain environmental conditions, such as rain or saltwater, that cause the snap fasteners to rust or pit. Once the snap heads and snap bases have rusted, releasing or unsnapping the snap fasteners by hand often becomes extremely difficult. Furthermore, using a screwdriver or other tool to release a rusted snap fastener may result in permanent damage to the surface to which the snap base is attached.

Thus, there is a need for a hand-held device that can effectively open or release snap fasteners without damaging the covering material, the surface to which the snap base is attached, or the snap fasteners themselves.

### SUMMARY OF THE INVENTION

The present invention provides a hand-held tool for opening snap fasteners. A preferred embodiment of this invention includes a wedge-shaped unsnapping element that is compatible with snap fasteners of various sizes. The unsnapping element further includes two notched plates. Each notched plate is attached at an angle to one of two arms, each arm having a grip at the end opposite the end to which the notched plate is attached. The two arms are held together by a hinge, and a spring, or other resistance-providing device, located near the hinge provides sufficient force to keep the two notched plates together when the device is in the closed position. The user of the device simply places the unsnapping element between the head and base of a closed snap fastener and squeezes the grips together. The two notched plates separate and the closed snap fastener is easily opened.

Further advantages of the present invention will become apparent to those of ordinary skill in the art upon reading and understanding the following detailed description of the preferred embodiments.

### BRIEF DESCRIPTION OF THE DRAWINGS

FIG. 1A is a side view of the snap release device of the present invention in the closed position.

FIG. 1B is a side view of the snap release device of the present invention in the open position.

FIG. 2 is a top view of the snap release device of the present invention depicting the preferred shape of the unsnapping element.

### DETAILED DESCRIPTION OF THE INVENTION

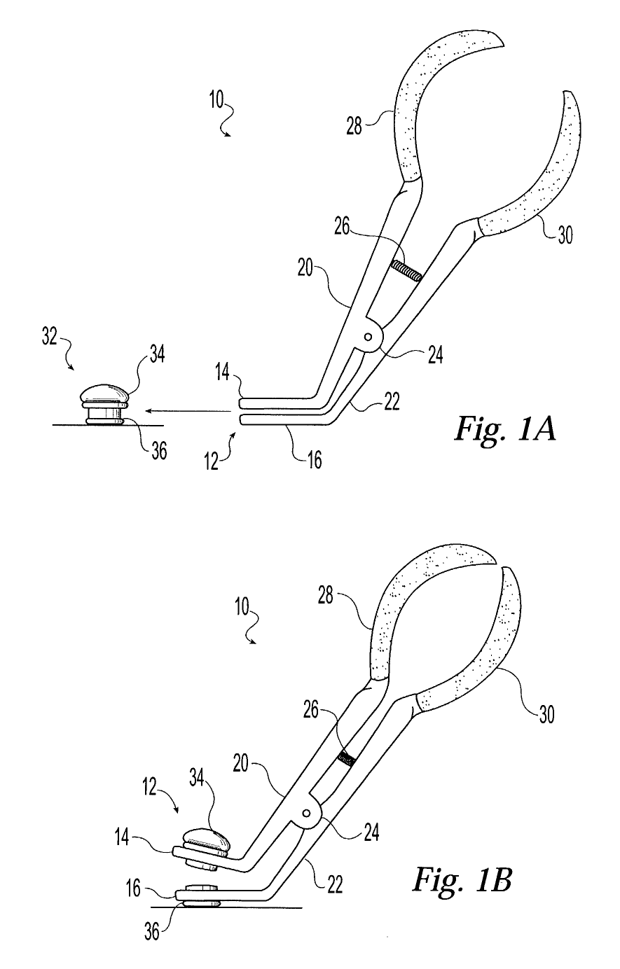

As best shown by FIGS. 1A and 1B, and according to a preferred embodiment of the present invention, snap release device 10 comprises unsnapping element 12, first arm 20, second arm 22, spring 26, first grip 28 and second grip 30. First arm 20 and second arm 22 both include a front portion and a rear portion. Unsnapping element 12 further comprises first notched plate 14 and second notched plate 16. Preferably, first notched plate 14 is attached to the front portion of first arm 20 at an inner angle of about 135°, and second notched plate 16 is attached to the front portion of second arm 22 at an inner angle of about 135° (see FIGS. 1A and 1B). When snap release device 10 is in the closed position, first notched plate 14 is held near to or against second notched plate 16 by the force created by spring 26. Together, the two notched plates form unsnapping element 12. In the context of this invention, the term “spring” refers to an actual spring, or to any other type of device, member, or structure that provides the force or resistance necessary to keep first notched plate 14 and second notched plate 16 in close proximity to one another when snap release device 10 is not being used. Additionally, “in close proximity” means “very near to” or “in contact with”. The angle of unsnapping element 12 relative to the first and second arms makes this invention easier for the user to operate because when properly used, unsnapping element 12 is positioned roughly parallel to the surface to which snap base 36 has been attached.

As shown in FIGS. 1A and 1B, first arm 20 further comprises a portion of hinge 24 and second arm 22 further comprises the remaining portion of hinge 24. When snap release device 10 is properly assembled, hinge 24 permits the rear portions of first arm 20 and second arm 22 to be brought together, thereby causing first notched plate 14 to separate from second notched plate 16. In a preferred embodiment, first grip 28 is located at the end of first arm 20 opposite first notched plate 14. Likewise, second grip 30 is located at the end of second arm 22 opposite second notched plate 16. As shown in FIGS. 1A and 1B, both first grip 28 and second grip 30 are arc-shaped and may be covered or fitted with a non-slip material such as plastic, rubber, or other similar material to provide the user of snap release device 10 with more control over the device. In an alternate embodiment, first grip 28 and second grip 30 are not arc-shaped, but rather are straight extensions of first arm 20 and second arm 22.

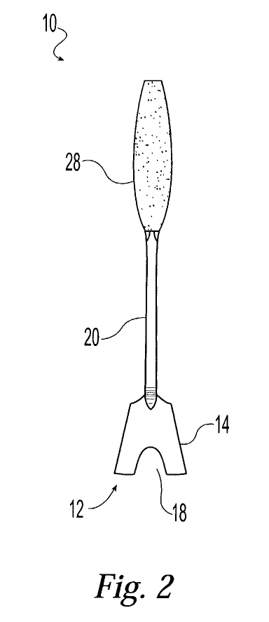

Snap release device 10 may be used to release closed snaps or fasteners of varying sizes. In the context of this invention, the term “release” means open, unsnap, release, or separate. Snap release device 10 may also be manufactured to have different dimensions for specific applications. As shown in FIG. 2, notch 18, which is formed by first notched plate 14 and second notched plate 16, preferably tapers inward such that the outermost edge of notch 18 is wider than innermost edge of the notch. The tapered or wedge shape of the notch helps guide unsnapping element 12 into position, and also makes snap release device 10 compatible with a variety of snap fasteners.

With snap release device 10 in the closed position, the user of the device simply approaches closed snap fastener 32, and with one hand or both hands around first grip 28 and second grip 30, places unsnapping element 12 between snap head 34 and snap base 36, and firmly squeezes first grip 28 and second grip 30 together. First notched plate 14 separates from second notched plate 16, and snap fastener 32 opens. When used properly, snap release device 10 causes no damage to the covering material, the surface to which the snap base is attached, or the snap fastener itself.

While the above description contains many specificities, these should not be construed as limitations on the scope of the invention, but rather as exemplification of preferred embodiments. Numerous other variations of the present invention are possible, and it is not intended herein to mention all of the possible equivalent forms or ramifications of this invention.

What is claimed:

1. A device for releasing closed snap fasteners comprising:
(a) a first arm, said first arm further comprising:
(i) a front portion and a rear portion;
(ii) a first notched plate attached to said front portion of said first arm; and
(iii) a first hinge portion; and
(b) a second arm, said second arm further comprising:
(i) a front portion and a rear portion;
(ii) a second notched plate attached to said front portion of said second arm; and
(iii) a second hinge portion connected to said first hinge portion.

2. The device of claim 1, further comprising a spring located between said first arm and said second arm for providing force sufficient to keep said first notched plate in close proximity to said second notched plate when said device is not being used.

3. The device of claim 1, wherein said first arm further comprises a first grip attached to said rear portion of said first arm.

4. The device of claim 3, wherein said first grip further comprises non-slip material that is fitted over said first grip.

5. The device of claim 1, wherein said second arm further comprises a second grip attached to said rear portion of said second arm.

6. The device of claim 5, wherein said second grip further comprises non-slip material that is fitted over said second grip.

7. The device of claim 1, wherein the inner angle between said first notched plate and said first arm is about 135°.

8. The device of claim 1, wherein the inner angle between said second notched plate and said second arm is about 135°.

9. The device of claim 1, wherein the notch formed by said first notched plate and said second notched plate is tapered inward such that outermost edge of said notch is wider than the innermost edge of said notch.

10. A method of releasing closed snap fasteners comprising the steps of:
(a) providing a snap release device, said device further comprising: a first arm, said first arm further comprising a front portion and a rear portion, a first notched plate attached to said front portion of said first arm, and a first hinge portion; and a second arm, said second arm further comprising a front portion and a rear portion, a second notched plate attached to said front portion of said second arm; and a second hinge portion connected to said first hinge portion.
(b) with said first notched plate and said second notched plate in contact with one another to form an unsnapping element, placing said unsnapping element between the base and head of a closed snap fastener; and
(c) with one or both hands squeezing said first arm and said second arm together to force said first notched plate and said second notched plate apart, releasing said closed snap fastener.
